(19) United States
(12) Patent Application Publication
(10) Pub. No.: US 2019/0077043 A1
(43) Pub. Date: Mar. 14, 2019

(54) PRESSING TOOL DESIGNED AS A PRESS PLATEN

(71) Applicant: HUECK Rheinische GmbH, Viersen (DE)

(72) Inventor: Rolf ESPE, Bochum (DE)

(73) Assignee: HUECK Rheinische GmbH, Viersen (DE)

(21) Appl. No.: 15/773,614

(22) PCT Filed: Nov. 8, 2016
(86) PCT No.: PCT/EP2016/076984

§ 371 Date: May 4, 2018

(30) Foreign Application Priority Data
Nov. 10, 2015 (DE) 20 2015 007 762.5

(51) Int. Cl. B27N 3/20; B27N 7/00; B30B 15/06

(52) U.S. Cl. CPC B27N 3/203; C08L 79/08; B30B 15/062; B27N 7/005

(57) ABSTRACT

The invention relates to a pressing tool for coating wood panels in hydraulic hot presses, which is designed as a press platen (1) made of a high temperature-resistant polyether ether ketone (PEEK)-type synthetic material and the surface (2) of which is structured or smooth with different degrees of gloss.

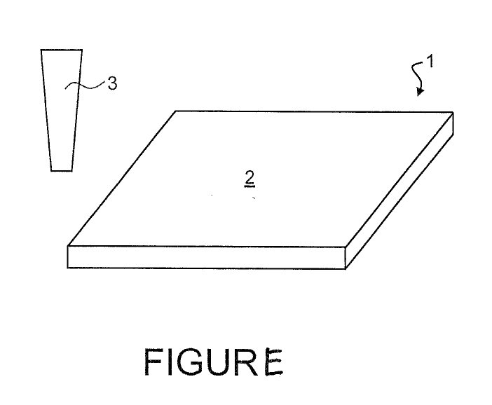

The invention relates to a pressing tool designed as a press platen for coating wood panels in hydraulic press machines.

The coated wood panels are used as furniture panels or floor panels for example, the surfaces of which are provided with synthetic resin films. As a rule, the synthetic resin films consist of printed or uni-colored cellulose papers and are impregnated with the precondensed resins in so-called impregnation plants and then further condensed to a specific moisture content of ca. 8% in a heated drying zone. The synthetic resin films consist of so-called aminoplast resins with a base of melamine and formaldehyde or mixed resins of melamine/urea and formaldehyde, for example. These mixtures are firstly precondensed at a specific condensation temperature and pH value in a reaction vessel with an agitator until they have reached the desired viscosity and the desired degree of crosslinking. These so-called precondensates are used for impregnating the paper. Impregnation of the papers takes place during the impregnation process. This is followed by drying in horizontal carrier air passages at ca. 125 to 155° C. This process step initially constitutes an additional polycondensation which is interrupted after the drying zone. The synthetic resin films are initially solid and readily transportable so that they can be effectively processed in the hydraulic press machines. Coating of the wood panels, formulated as MDF, HDF, chipboard or plywood panels, takes place in so-called hydraulically heatable press machines. The heating plates are affixed to corresponding press platens, the surfaces of which are structured or smooth and have different degrees of gloss. Press pads made from elastic materials are inserted between the heating plates and press platens, which serve as pressure compensating means and are intended to compensate the thickness tolerances of the press platens and press machine. The coated product consisting of the synthetic resin films and the wood panels are fed into the heated press machine, the machine is closed and the required pressing pressure applied accordingly. As a result, the precondensed aminoplast resins become liquid again and condensation and hence three-dimensional crosslinking of the resins continues. This increases the viscosity of the resins until they are transformed into the solid and irreversible state of the resins after a specific time. During this process, the surface of the resins is also formed and it assumes exactly the corresponding surface of the press platens used in terms of structure and degree of gloss. Based on the prior art, metal press platens are used as a rule, made from a brass material from the MS 64 material group or chromium steels conforming to DIN 1.4024 corresponding to AISI 410 or DIN 1.4542 corresponding to AISI 630. Other metal materials cannot be used as press platens due to their purity, surface formation or technical data. The purity of the material plays a very crucial role when it comes to surface processing, for example. The chromium steels used must not have any cavities that would result in faults during subsequent surface processing. The specified chromium steels are melted under vacuum and therefore exhibit a uniform and clean metal structure during the rolling process. In order to produce the press platens, the rolled raw sheets firstly have to be polished in order to obtain a specific thickness tolerance. Where possible, this should be small and tolerances of 0.10 to 0.15 mm are achieved as a rule. Other stages of processing following this are buffing or fine polishing with a view to eliminating polishing marks as far as possible by the stage of the tolerance grind. A subsequent polishing constitutes the preparatory stage for surface processing. If the intention is to provide the surface with a structure, this can be produced in a manner known from the prior art by a chemical etching process using an etching acid consisting of FeCl₃. However, another option is to remove the metal needed to produce the structure by means of a laser. Solid-state lasers are used for this purpose but the ablation times are very long and are thus still not economical when working with large format sheets at the moment. Another theoretical method is to apply metal and thus apply the structure by a 3D printing process. However, neither of the specified methods is currently used as yet. Etching therefore remains the production method currently used. Based on the chemical etching process, an etch resist is firstly applied to the pre-prepared sheet surface by means of screen printing, rotary printing or digitally using an ink jet print head. An older method using a photoelectric layer which is then illuminated and fixed is barely used any more these days. After the etch resist has been applied, the sheet is treated accordingly in an acid bath with FeCl₃. The free unprinted surfaces without any etch resist are attacked by the acid and metal is removed accordingly to the desired structure depth. In other process steps, the structures can then be rounded or shaped accordingly. The degree of gloss of the structured sheet surfaces is adjusted in an irradiation process using differing radiation media and radiation pressures depending on the desired degree of gloss.

The last processing stage is the subsequent chrome plating process to protect the sheet surfaces from abrasion and obtain a good release effect from the aminoplast resins. Producing structure by the chemical etching process is a complex and difficult production process because the structure depths cannot be measured during the etching process, for example. The process is therefore operated on the basis of etching time on the assumption that the structure depth will always be the same depending on timing. In practice, however, it has been found that this is not the case because different parameters have a considerable effect on the etching time and hence on the etched depth of the structure. Acid temperature, acid pressure during spray etching and acid concentration are all factors which affect the etching process. Another disadvantage of FeCl₃ is that it is harmful to health because it irritates the skin and poses a risk of serious eye damage.

Steel or brass sheets are difficult to secure in the press systems because of their weight and very high clamping pressures are necessary in the case of the top sheets in particular. However, high clamping pressures can also lead to tension in the sheets if they are not correctly set up in the machines. A high degree of sagging occurs due to the heaviness of the sheets and they undergo an expansion when forced into the horizontal hold as the press is closed. Further expansion occurs under pressure because the heating plate temperature is significantly higher than the sheet temperature. If the sheets are unable to expand in the clamping devices, which are located outside the heating plates, the phenomenon known as plastic tension occurs in the sheet. In the cold state, the sheets are no longer flat, which means that they cannot undergo further processing and have to be scrapped. When working with steel sheets, it has been found that wear of the press pads has a very detrimental effect. The rear faces of the steel sheets have a specific roughness because relative movements occur during the pressing operation and the sheet rear faces rub on the press pads which are provided with soft metal threads in the form of Cu or Ms threads. The metal threads are necessary in order to transmit heat from the heating plate via the press platen to the product being pressed. Abrasion then leads to thin metal threads which are no longer able to absorb the high tensile stresses within the pads and tear. The pads are thus rendered unusable. The use of metal press platens for coating wood panels is therefore not satisfactory.

Accordingly, the underlying objective of the invention is to specify an improved pressing tool designed as a press platen.

The objective of the invention is achieved by a pressing tool for coating wood panels in hydraulic hot presses that is designed as a press platen made from a high temperature-resistant polyether ether ketone (PEEK)-type synthetic material and the surface of which is structured or smooth with different degrees of gloss. The objective of the invention is achieved in particular by a pressing tool designed as a press platen for coating wood panels in hydraulic hot presses, the surface of which is structured or smooth with different degrees of gloss, and the press platen is made from a high temperature-resistant polyether ether ketone (PEEK)-type synthetic material, the softening point of which lies above the processing temperature of the press machines.

Polyether ether ketones are relatively light and more practical in terms of handling, and more processes are available for the structuring operation which are less damaging to health and more reliable in terms of processing, and the negative properties of metal press platens can therefore be eliminated. Surprisingly, PEEK sheets have exhibited a high strength in spite of a significantly lower density of 1.31 kg/dm³ and PEEK containing 30% CA of 1.41 kg/dm³. A steel sheet conforming to a quality specified by DIN 1.4542 or AISI 630 has a density of 7.8 kg/dm³. This means that a press platen of the format 6200×2400 mm with a 5 mm thickness has a total weight of ca. 580 kg whereas a PEEK sheet of the same size weighs only 97 kg and a PEEK sheet containing 30% CA weighs 105 kg. The steel sheet is therefore almost 6 times heavier than a synthetic material sheet. Synthetic material sheets can therefore be more easily mechanically secured in the press machine and do not cause the problems described above which can occur when using metal press platens. However, it is also possible to secure synthetic material sheets in the press machine directly by means of the press pads using a chemical mechanism. Due to the lower degree of sagging of the sheets and the advantageous friction factor, the press pads, especially their metal threads, are protected from abrasion, thereby extending the service life of the pads. Different production processes are available for structuring the surfaces of synthetic material sheets. Since they do not involve treatment using etching media, for example FeCl₃, the methods are more environmentally friendly and not harmful to health. One type of structuring is fused deposition modeling, FDM, also known as fused filament fabrication, FFF. In the fused deposition method, similarly to a normal printer, a pattern of dots is firstly applied to a surface, the dots being formed by liquefying a filamentous synthetic material by heating, applying it by extrusion by means of a nozzle, followed by setting by cooling in the desired position to create a pattern in the working plane. The structure is usually built up by repeatedly passing line by line across a working plane and then shifting the working plane upwards in a stacking arrangement so that a structure is created in layers. Depending on the desired structure depth, the layer thicknesses are between 25 and 1250 μm. Data transmission is handled by means of CAD technology.

The press platen may be made of polyether ether ketone PEEK reinforced with at least 10 to 50% of a carbon fiber or with at least 10 to 50% of a graphite powder or with at least 10 to 50% of a thermally conductive material.

The press platen may be made of a polyimide PI, a polyamide imide PAI, a polyether ketone PEK, a polyether ketone ether ketone ketone PEKEKK, a polyphenylene sulfide PPS, a polyarylether ketone PAEK, a polybenzimidazole PBI or a liquid crystal polymer LCP.

Laser technology offers another technology for producing structure. By contrast with producing press platens using metal, a CO₂ laser may be used when working with PEEK sheets which requires substantially higher ablation times than is the case when removing a metal. In the case of the metal sheet produced as specified by EP 2 289 708 B1, it is proposed that the structuring be produced by means of a laser, and the laser is a pulsed fiber laser. In practice, however, it has been found that the removal rate of the pulsed fiber laser is very low. In the case of the CO₂ laser, as with every laser, a so-called active laser medium, in this case carbon dioxide CO₂, is pumped by feeding in external energy. In the medium itself, atomic processes then take place which ultimately case a chain reaction using a complex apparatus and hence the emission of laser light. The CO₂ laser is also referred to as a gas laser. A gas laser can much more easily produce a larger volume of active laser material than a solid-state laser, for example because the container used for this purposes merely has to be of sufficiently large dimensions and accordingly allows an inflow of a large amount of gas. The volume has a direct bearing on the intensity of the lasers that can be obtained and greater power ratings can therefore also be achieved as a result. The CO₂ laser has a long wavelength and is therefore readily absorbed by synthetic materials, whereas metal surfaces are highly reflective and removal is therefore lower. A power of 200 to 300 Watt is already sufficient to obtain good removal rates in the case of synthetic materials. By setting up digitized data of a 3-D topography of a structure removed beforehand, the laser is controlled in an x-coordinate and a y-coordinate and the depth is determined by the z-coordinate of the 3-D topography perpendicular to the surface structure.

Another option for producing structure is die pressing. By contrast with metals, structures can be produced in synthetic materials due to the effect of temperature and pressure. A negative structure serving as the prototype is produced in a steel sheet first of all. This prototype serves as a means of imparting structure to all the other synthetic material press platens. Subjected to pressure and a temperature below the melting point of the synthetic material but still above the softening point, the negative structure is embossed in the synthetic material sheet and thus receives a positive structure. The product being pressed is cooled under pressure and to just below the softening point of the synthetic material used and the pressed product is then removed.

Reproducible structures can be produced by these methods. By contrast with the structures produced in metal press platens by the chemical etching process, these structures are all identical and exhibit no deviations. In this manner, a structure production process is possible which is reliable in terms of processing and poses no risk to health. After structuring, the sheet surfaces can also be additionally processed in the same way as metal press platens. The degree of gloss is set by means of radiation media at a specific radiation pressure, depending on the desired degree of gloss. To protect the surfaces, the synthetic material sheets may also be chromed but it is recommendable to apply a Cu-layer. This may be achieved by a reductive copper plating for synthetic materials for example, or by an electroless process of copper plating of synthetic materials using Baymetec and Baycoflex. After copper plating, the usual chrome plating can be applied in galvanic baths. Tests have demonstrated that not every synthetic material is suitable for use as press platens in hydraulic hot presses for coating synthetic materials. The softening point of the synthetic materials must be far above the processing temperature prevailing in the hot presses. As a rule, this is between 190 and 220° C. The polyether ether ketone (PEEK)-type synthetic material reinforced with ca. 30% carbon fiber or with graphite has been found to be surprisingly good for producing press platens. Although synthetic materials have a poorer thermal conductivity than metals, it was possible to largely compensate for these differences by adding a carbon fiber or by graphite powder. Furthermore, due to their lightness, it was possible to secure the synthetic material sheets more effectively and tightly to the heating plates so that the heat loss which occurs in the case of metal press platens due to their high degree of sagging did not occur in this instance. These advantages also compensate for the different thermal conductivities.

The different degrees of gloss can also be obtained by different coatings of the surface of the press platen made of a high temperature-resistant synthetic material of the polyether ether ketone type, as described in EP 2 060 658 B1.

An example of an embodiment of the invention is illustrated in the appended schematic drawing, which illustrates a pressing tool designed as a press platen 1.

The press platen 1 is made from a high temperature-resistant polyether ether ketone synthetic material and comprises a surface 2 which is structured or smooth with different degrees of gloss.

In the case of this example of an embodiment, the press platen 1 is reinforced with at least 10 to 50% of a carbon fiber or with at least 10 to 50% of a graphite powder or with at least 10 to 50% of a thermally conductive material.

The press platen 1 may be made of a polyimide, a polyamide imide, a polyether ketone, a polyether ketone ether ketone ketone, a polyphenylene sulfide, a polyarylether ketone, a polybenzimidazole or a liquid crystal polymer LCP for example.

In the case of this example of an embodiment, the structuring of the surface 2 of the press platen 1 was produced by means of a CO₂ laser 3. In particular, digitized data of a 3-D topography of a previously removed structure corresponding to the structuring of the surface 2 was used for a controller of X-, Y- and Z-coordinates of the CO₂ laser 3.

The structuring of the surface 2 of the press platen 3 may also be obtained by means of a die pressing process or by the fused deposition modeling method.

1-13. (canceled)

14: A pressing tool for coating wood panels in hydraulic hot presses, which is designed as a press platen (1) made of a high temperature-resistant synthetic material of the polyether ether ketone (PEEK)-type and the surface (2) of which is structured or smooth with different degrees of gloss, wherein the press platen (1) made of polyether ether ketone PEEK is reinforced with at least 10% to 50% of a carbon fiber or with at least 10% to 50% of a graphite powder or with at least 10% to 50% of a thermally conductive material.

15: The pressing tool according to claim 14, wherein the press platen (1) is made of a polyimide (PI).

16: The pressing tool according to claim 14, wherein the press platen (1) is made of a polyamide imide (PAI).

17: The pressing tool according to claim 14, wherein the press platen (1) is made of a polyether ketone (PEK).

18: The pressing tool according to claim 14, wherein the press platen (1) is made of a polyether ketone ether ketone ketone (PEKEKK).

19: The pressing tool according to claim 14, wherein the press platen (1) is made of a polyphenylene sulfide (PPS).

20: The pressing tool according to claim 14, wherein the press platen (1) is made of a polyarylether ketone (PAEK).

21: The pressing tool according to claim 14, wherein the press platen (1) is made of a polybenzimidazole (PBI).

22: The pressing tool according to claim 14, wherein the press platen (1) is made of a liquid crystal polymer (LCP).

23: The pressing tool according to claim 14, wherein the structuring of the surface (2) of the press platen (1) is produced by a die pressing process.

24: The pressing tool according to claim 14, wherein the structuring of the surface (2) of the press platen (1) is produced by a fused deposition modeling method (FDM).

25: The pressing tool according to claim 14, wherein the structuring of the surface (2) of the press platen (1) is produced by means of a CO₂ laser (3) and digitized data of a 3-D topography of a previously removed structure corresponding to the structuring of the surface (2) is used for a controller of X-, Y- and Z-coordinates of the CO₂ laser (3).
